(19) United States
(12) Patent Application Publication
(10) Pub. No.: US 2014/0147067 A1
(43) Pub. Date: May 29, 2014

(54) BEARING MODULE FOR MOTOR

(71) Applicant: SAMSUNG ELECTRO-MECHANICS CO., LTD., Suwon (KR)

(72) Inventors: Jin Su Seok, Suwon (KR); Jin Wook Baek, Suwon (KR); Hyun Taek Ahn, Suwon (KR); Young Bok Yoon, Suwon (KR)

(73) Assignee: Samsung Electro-Mechanics Co., Ltd., Suwon (KR)

(21) Appl. No.: 13/801,519

(22) Filed: Mar. 13, 2013

(30) Foreign Application Priority Data
Nov. 23, 2012 (KR) 10-2012-0133841

(51) Int. Cl. F16C 17/02; F16C 33/02

(52) U.S. Cl. CPC F16C 17/02; F16C 33/02
USPC 384/397

(57) ABSTRACT

Disclosed herein is a bearing module for a motor that rotatably supports a rotational shaft and is sintered and molded, including: an upper bearing; and a lower bearing coupled to the upper bearing, wherein an oil receiving portion is formed in at least one of the upper bearing and the lower bearing.

### CROSS REFERENCE TO RELATED APPLICATION

This application claims the benefit of Korean Patent Application No. 10-2012-0133841, filed on Nov. 23, 2012, entitled “Bearing Module for Motor”, which is hereby incorporated by reference in its entirety into this application.

### BACKGROUND OF THE INVENTION

1. Technical Field

The present invention relates to a bearing module for a motor.

2. Description of the Related Art

Motors use a ball bearing or a sleeve bearing according to the type thereof.

Further, in the case where the sleeve bearing is adopted, a contact portion with a shaft is broadened when the length of the sleeve bearing increases, and as a result, swing can be reduced and friction becomes larger.

Further, in the case where the sleeve bearing is manufactured by sintered molding, a porous is impregnated with oil and when the shaft rotates and a temperature and pressure increase, oil flows out from the porous to reduce friction.

However, a sintering bearing in the related art including Patent Document below, which includes a patent document described below is short in life-span because oil supply is limited, and as a result, reliability of the motor deteriorates.

### Related Art Document

### Patent Document

(Patent Document 1) US 20100310199 A

### SUMMARY OF THE INVENTION

The present invention has been made in an effort to provide a bearing module that can improve a life-span of a bearing and reliability of a motor as an upper bearing and a lower bearing are formed by sintered molding and an oil receiving portion is formed in at least one of the upper bearing and the lower bearing.

Further, the present invention has been made in an effort to provide a bearing module that can improve a life-span of a bearing and reliability of a motor while preventing oil from flowing out by forming an upper bearing and a lower bearing by sintered molding, forming an oil receiving portion in at least one of the upper bearing and the lower bearing, and inserting an oil containing member into the oil receiving portion.

According to a first preferred embodiment of the present invention, there is provided a bearing module for a motor that rotatably supports a rotational shaft and is sintered and molded, including: an upper bearing; and a lower bearing coupled to the upper bearing, wherein an oil receiving portion is formed in at least one of the upper bearing and the lower bearing.

The plurality of oil receiving portions may be formed in a circumferential direction of the upper bearing or the lower bearing at equidistance.

Coupling portions constituted by protrusions and grooves which correspond to each other may be formed in the upper bearing and the lower bearing, and the protrusions and the grooves may be engaged with each other, such that the upper bearing and the lower bearing are coupled to each other.

The coupling portions may be formed so that the protrusions and the grooves are repeated in the circumferential direction.

The plurality of grooves of the coupling portions may correspond to the oil receiving portions and the plurality of protrusions may be formed in areas among the oil receiving portions.

The bearing module for a motor may further include an oil containing member inserted into the oil receiving portion.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic perspective view of a bearing module for a motor according to a first preferred embodiment;

FIG. 2 is a schematic exploded perspective view of the bearing module for a motor illustrated in FIG. 1; and

FIG. 3 is a schematic cross-sectional view of a bearing module for a motor according to to a second preferred embodiment.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

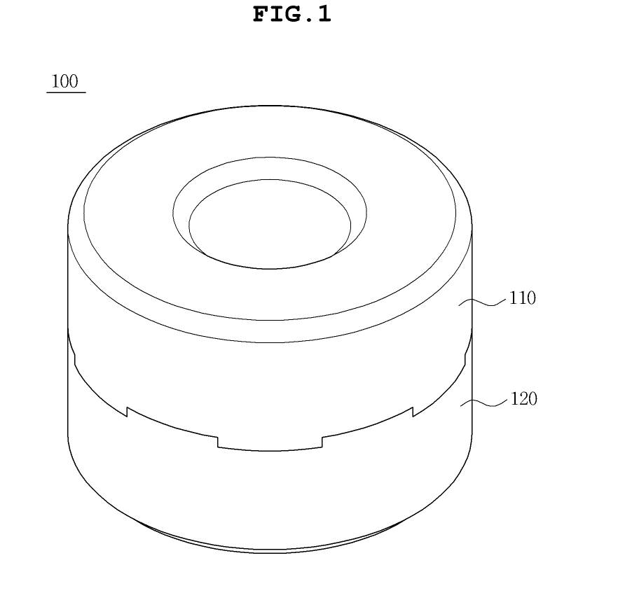

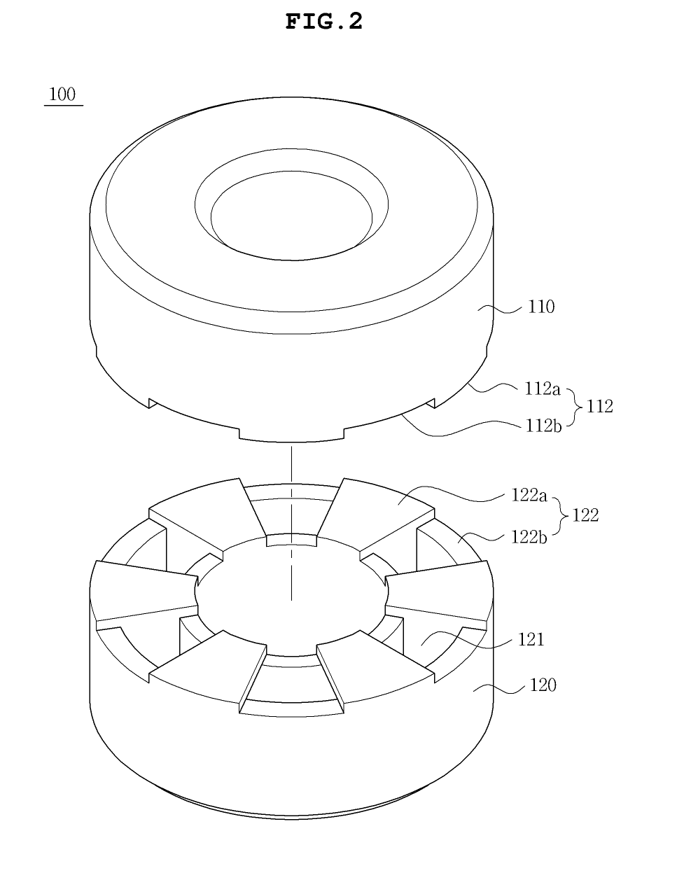

FIG. 1 is a schematic perspective view of a bearing module for a motor according to a first preferred embodiment. FIG. 2 is a schematic exploded perspective view of the bearing module for a motor illustrated in FIG. 1. As illustrated in the figure, the bearing module 100 for a motor includes an upper bearing 110 and a lower bearing 120.

Further, the upper bearing 110 and the lower bearing 120 are formed by sintering bearings and coupling portions which correspond to each other are formed so that the upper bearing 110 and the lower bearing 120 are coupled to each other.

In more detail, the upper bearing 110 has a hollow portion so that a rotational shaft (not illustrated) is inserted into an inner diameter portion and has a cylindrical shape. Further, the upper bearing 110 has an oil receiving portion (not illustrated) which is a groove capable of receiving oil therein. In addition, the plurality of oil receiving portions may be formed in a circumferential direction of the upper bearing 110 at equidistance.

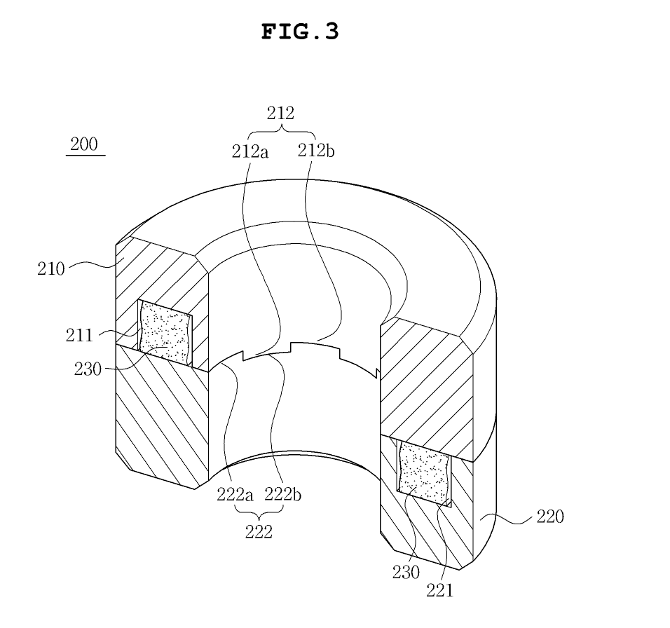

The oil receiving portion has the same shape as an oil receiving portion 121 of the lower bearing 120 to be described below and is illustrated in a bearing module according to another preferred embodiment of FIG. 3. Therefore, this is apparent by those skilled in the art and may be easily implemented.

A coupling portion 112 is formed on one surface of the upper bearing 110 facing the lower bearing 120 coupled to a lower portion thereof. The coupling portion 112 may be formed so that a protrusion 112a and a groove 112b are repeated.

The plurality of grooves 112b are formed to correspond to the oil receiving portion and the plurality of protrusions 112a may be formed in areas among the oil receiving portions.

The lower bearing 120 has the cylindrical shape of the same size as the upper bearing 110 and has the oil receiving portion 121 capable of receiving oil therein. The plurality of oil receiving portions 121 may be formed in a circumferential direction of the lower bearing 120 at equidistance similarly as the oil receiving portion of the upper bearing 110.

A coupling portion 122 is formed on one surface of the lower bearing 120 facing the upper bearing 110 coupled to an upper portion thereof and the coupling portion 122 is formed so that a protrusion 122a and a groove 122b are repeated.

That is, the protrusion 122a of the lower bearing 120 corresponds to the groove 112b of the upper bearing 110 and the groove 122b of the lower bearing 120 corresponds to the protrusion 112a of the upper bearing 110.

The plurality of grooves 122b may correspond to the oil receiving portions 121 and the plurality of protrusions 122a may be formed to correspond to areas among the oil receiving portions 121 or the grooves 122b.

As described above, as the bearing module 100 for a motor according to the first preferred embodiment of the present invention is engaged in such a manner that the protrusion 112a of the upper bearing 110 and the groove 122b of the lower bearing 120 are coupled to each other and the groove 112b of the upper bearing 110 and the protrusion 122a of the lower bearing 120 are coupled to each other, the upper bearing 110 and the lower bearing 120 are coupled to each other.

In this case, as oil is stored in the oil receiving portion of the upper bearing 110 and the oil receiving portion 121 of the lower bearing 120, the bearing module 100 for a motor according to the present invention, which is configured by the sintering bearing may be implemented to have an improved life-span and a more stable bearing structure.

As the upper bearing 110 and the lower bearing 120 are configured by the sintering bearings, the upper bearing and the lower bearing are coupled to each other by compression processing and an airtightness effect is improved by the coupling portion.

FIG. 3 is a schematic cross-sectional view of a bearing module for a motor according to a second preferred embodiment.

As illustrated in the figure, the bearing module 200 for a motor according to the second preferred embodiment further includes an oil containing member 230 as compared with the bearing module 100 for a motor according to the first preferred embodiment.

In more detail, the bearing module 200 for a motor includes an upper bearing 210 and a lower bearing 220.

The upper bearing 210 and the lower bearing 220 are formed by the sintering bearings and coupling portions which correspond to each other are formed so that the upper bearing 210 and the lower bearing 220 are coupled to each other, like the bearing module 100 according to the first preferred embodiment.

In more detail, the upper bearing 210 has a hollow portion so that a rotational shaft (not illustrated) is inserted into an inner diameter portion and has a cylindrical shape. Further, the upper bearing 210 has an oil receiving portion 211 which is a groove capable of receiving oil therein. In addition, the plurality of oil receiving portions 211 may be formed in a circumferential direction of the upper bearing 210 at equidistance.

A coupling portion 212 is formed on one surface of the upper bearing 210 facing the lower bearing 220 coupled to a lower portion thereof. The coupling portion 212 may be formed so that a protrusion 212a and a groove 212b are repeated.

The plurality of grooves 212b may correspond to the oil receiving portions 211 and the plurality of protrusions 212a may be formed to correspond to areas among the oil receiving portions 211 or the grooves 212b.

The lower bearing 220 has the cylindrical shape of the same size as the upper bearing 210 and has an oil receiving portion 221 capable of receiving oil therein. The plurality of oil receiving portions 221 may be formed in a circumferential direction of the lower bearing 220 at equidistance similarly as the oil receiving portion 211 of the upper bearing 210.

A coupling portion 222 is formed on one surface of the lower bearing 220 facing the upper bearing 210 coupled to an upper portion thereof and the coupling portion 222 is formed so that a protrusion 222a and a groove 222b are repeated.

That is, the protrusion 222a of the lower bearing 220 corresponds to the groove 212b of the upper bearing 210 and the groove 222b of the lower bearing 220 corresponds to the protrusion 212a of the upper bearing 210.

The plurality of grooves 222b may correspond to the oil receiving portions 221 and the plurality of protrusions 222a may be formed to correspond to areas among the oil receiving portions 221.

The bearing module 200 further includes an oil containing member 230 which inserted into the oil receiving portion 211 of the upper bearing 210 and contains oil.

The oil containing member 230 may be made of various materials which can easily contain oil, such as nonwoven fabric, felt, fiber, and the like.

As described above, as the bearing module 200 for a motor according to the second preferred embodiment of the present invention is engaged in such a manner that the protrusion 212a of the upper bearing 210 and the groove 222b of the lower bearing 220 are coupled to each other and the groove 212b of the upper bearing 210 and the protrusion 222a of the lower bearing 220 are coupled to each other, the upper bearing 210 and the lower bearing 220 are coupled to each other.

In this case, as oil is stored in the oil receiving portion 211 of the upper bearing 210 and the oil receiving portion 221 of the lower bearing 220, and the oil containing member 230 is received in the oil receiving portions 211 and 221, the bearing module 200 for a motor according to the present invention, which is configured by the sintering bearing may be implemented to have an improved life-span and a more stable bearing structure.

As the upper bearing 210 and the lower bearing 220 are configured by the sintering bearings, the upper bearing and the lower bearing are coupled to each other by compression processing and an airtightness effect is improved by the coupling portion.

According to preferred embodiments of the present invention, a life-span of a bearing and reliability of a motor can be improved as an upper bearing and a lower bearing are formed by sintered molding and an oil receiving portion is formed in at least one of the upper bearing and the lower bearing and furthermore, a life-span of a bearing and reliability of a motor can be improved while oil can be prevented from flowing out by inserting an oil containing member into the oil receiving portion.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A bearing module for a motor that rotatably supports a rotational shaft and is sintered and molded, comprising:
an upper bearing; and
a lower bearing coupled to the upper bearing,
wherein an oil receiving portion is formed in at least one of the upper bearing and the lower bearing.

2. The bearing module for a motor as set forth in claim 1, wherein the plurality of oil receiving portions are formed in a circumferential direction of the upper bearing or the lower bearing at equidistance.

3. The bearing module for a motor as set forth in claim 2, wherein coupling portions constituted by protrusions and grooves which correspond to each other are formed in the upper bearing and the lower bearing, and the protrusions and the grooves are engaged to each other, such that the upper bearing and the lower bearing are coupled to each other.

4. The bearing module for a motor as set forth in claim 3, wherein the coupling portions are formed so that the protrusions and the grooves are repeated in the circumferential direction.

5. The bearing module for a motor as set forth in claim 3, wherein the plurality of grooves of the coupling portions correspond to the oil receiving portions and the plurality of protrusions are found in areas among the oil receiving portions.

6. The bearing module for a motor as set forth in claim 1, further comprising:
an oil containing member inserted into the oil receiving portion.
